(19) United States
(12) Patent Application Publication
(10) Pub. No.: US 2024/0294793 A1
(43) Pub. Date: Sep. 5, 2024

(54) AQUEOUS COATING COMPOSITION

(71) Applicant: Omya International AG, Oftringen (CH)

(72) Inventors: Fabien Wilhelm MONNARD, Aarburg (CH); Jan Philipp WEIHS, Düdingen (CH)

(21) Appl. No.: 18/566,287

(22) PCT Filed: Jun. 1, 2022
(86) PCT No.: PCT/EP2022/064838

§ 371 Date: Dec. 1, 2023

(30) Foreign Application Priority Data
Jun. 2, 2021 (EP) 21177407.0

(51) Int. Cl. C09D 123/08; C08J 7/052; C09D 5/00; C09D 7/40; C09D 7/61; C09D 7/80; C09D 133/08

(52) U.S. Cl. CPC C09D 123/0815; C08J 7/052; C09D 5/002; C09D 7/61; C09D 7/69; C09D 7/80; C09D 123/0876; C09D 133/08; C08J 2301/00

(57) ABSTRACT

The present invention relates to an aqueous coating composition. The aqueous coating composition comprises (a) a polymer A comprising units derived from an alpha-olefin and one or more comonomers selected from the group of methacrylates, acrylates, methacrylic acid, acrylic acid, maleates, maleic acid, maleic anhydride, and salts thereof; (b) a polymer B comprising units derived from one or more monomers selected from the group of methacrylates, acrylates, methacrylic acid, acrylic acid, maleates, maleic acid, maleic anhydride, and salts thereof; (c) a calcium carbonate-containing material in an amount in the range of 0.1 to below 20 wt. %, based on the total dry weight of the coating composition; and (d) optionally a wax. Furthermore, the invention relates to a process for preparing an aqueous coating composition according to invention, and to a coated article.

The present invention relates to an aqueous coating composition and a process for preparing the same. The invention further relates to an article which is coated with the aqueous coating composition, such as a paper or paperboard, and which is useful as packaging for beverages and/or food.

### BACKGROUND

Cellulose-based packaging materials such as paper, paper board, card board etc, for beverages or food are becoming more important as replacements or alternatives for traditional plastic containers. Paper-based products have to fulfill certain requirements to be useful as packaging material for beverage or food, and to be eventually accepted by industry and customer for such purposes. For example, paper-based packaging usually has to have certain minimum water and water vapor barrier properties. Certain minimum values in cold and hot water absorption tests (also known as COBB tests) and water vapor transmissions rates (WVTR) need to be achieved. Additionally, packaging must be grease or oil resistant. Further, paper-based packaging often has to be sealable or heat-sealable to form structures such as cups or containers or to provide such structures with lids or other type of sealing.

Raw paper or fiber substrates most often cannot fulfill any of the above requirements from the packaging sector. This is the reason why raw paper is usually laminated or extrusion-coated with a polymer film, e.g. PE film, to impart one or more of the desired functionalities to the paper. While polymer film lamination may improve functionality of paper as packaging material, it usually complicates recyclability of the cellulosic components of the packaging. This is mainly due to the comparatively high lamination weight of the polymer film. Water-based coating composition can improve recycling over conventional polymer films. However, coatings prepared from water-based compositions, often cannot simultaneously provide a paper substrate with all desired properties (e.g. barrier properties against hot and cold water, and oil; sealability; recyclability, etc.) while maintaining processability and cost-effectiveness. For example, some coatings may not sufficiently withstand hot tea, coffee or other hot beverages, which limits their use in e.g. coffee-to-go cups.

Hence, there is a continuous need in the art for aqueous coating compositions which can provide cellulose-based substrates for packaging with improved properties, especially improved hot water barrier properties, while maintaining processability and cost-effectiveness.

One object of the present invention is to provide an improved aqueous coating composition and an improved article which is coated therewith.

### SUMMARY OF INVENTION

One aspect of the present invention relates to an aqueous coating composition. The aqueous coating composition comprises
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) a calcium carbonate-containing material in an amount in the range of 0.1 to below 20 wt. %, based on the total dry weight of the coating composition; and
(d) optionally a wax.

One inventive finding of the present invention is that addition of a specific amount of a calcium carbonate-containing material, preferably a high purity calcium carbonate, to an aqueous polymer formulation can improve the properties of a coating which is prepared from such water-based coating formulation. Specifically, the addition of the specific amount of calcium carbonate-containing material decreases hot water absorption of a coated paper article. Thus, stability of the coated paper towards hot water is increased. At the same time other important parameter values of the coated article such as sealability, cold water COBB, WVTR, etc, are largely maintained. Thereby, the inventive coating composition is particularly useful for paper-based packaging which has to resist hot liquids such as cups for hot beverages or food containers which are heated to prepare the food within.

It has further been found that an article comprising the inventive coating can be better processed in hot air sealing machines than a comparable coating without a calcium carbonate-containing material. In particular, a coated article according to the invention shows less blocking in the coating machine and the sealing machine.

Another aspect of the present invention relates to a process for preparing the aqueous coating composition according to the invention. The process comprises the steps of:
providing an aqueous composition I comprising polymer A and optionally a wax,
providing an aqueous composition II comprising polymer B and optionally a wax,
providing a calcium carbonate-containing material,
mixing the aqueous compositions I and II and the calcium carbonate-containing material.

Another aspect of the present invention relates to a coated article. The coated article comprises a substrate, wherein at least one surface of the substrate comprises a coating prepared from an aqueous coating composition according to the invention.

Preferred embodiments of the invention are defined in the subclaims.

According to one embodiment of the present invention, the aqueous coating composition comprises polymer A and polymer B in a weight ratio of 50:50 to 99:1, preferably >65:<35 to 99:1, more preferably 70:30 to 99:1, and most preferably 75:25 to 95:5.

According to one embodiment of the present invention, the aqueous coating composition comprises 60 to 99.9 wt. %, preferably 75 to 99.9 wt. %, more preferably 85 to 95 wt. %, of a combined amount of polymers A and B, based on the total dry weight of the coating composition.

According to one embodiment of the present invention, the aqueous coating composition comprises the calcium carbonate-containing material in an amount of 0.1 to 12.5 wt. %, preferably 2 to 12.5 wt. %, and more preferably 2 to 8 wt. %, based on the total dry weight of the coating composition, and/or the calcium carbonate-containing material has a calcium carbonate content of at least 90 wt. %, preferably at least 95 wt. %, based on the total weight of the calcium carbonate-containing material.

According to one embodiment of the present invention, the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of the calcium carbonate-containing material, and
(d) optionally 1 to 15, preferably 5 to 12, more preferably 7 to 12, parts per weight of wax.

According to one embodiment of the present invention, the polymer A comprises, preferably consists of, units derived from an alpha-olefin, preferably ethylene, and one or more monomers selected from the group of methacrylates, acrylates, methacrylic acid, acrylic acid, and salts thereof.

According to one embodiment of the present invention, the polymer A is a copolymer of ethylene and acrylic acid.

According to one embodiment of the present invention, the polymer A has a comonomer content, preferably an acrylic acid content, in the range from 0.5 to 25 mol-%, and preferably from 5 to 25 mol-%.

According to one embodiment of the present invention, the polymer A has a comonomer content, preferably an acrylic acid content, in the range from 5 to 30 wt. %.

According to one embodiment of the present invention, the polymer B comprises, preferably consists of units, derived from one or more, preferably two to four, monomers selected from the group of methacrylates, acrylates, methacrylic acid, acrylic acid, and salts thereof.

According to one embodiment of the present invention, the polymer B is a polymer of acrylic acid and from one to three C₁-C₆ alkyl acrylate and/or C₁-C₆ alkyl methacrylate monomers.

According to one embodiment of the present invention, the calcium carbonate-containing material has a weight-median particle size d₅₀ in the range of 0.1 to 15 microns, preferably 0.1 to 5 microns, and more preferably 0.1 to below 0.8 microns, and/or the calcium carbonate-containing material has a top cut weight particle size d₉₈ in the range of 0.5 to 30 microns, preferably 0.5 to 20 microns, and more preferably 0.5 to below 4 microns.

According to one embodiment of the present invention, the wax is a hydrocarbon wax, preferably a paraffin wax.

According to one embodiment of the present invention, the aqueous coating composition has a solids content in the range of 5 to 70 wt. %, preferably of 20 to 60 wt. %, more preferably 30 to 50 wt. %, and/or the aqueous coating composition has a pH value in the range of 7.5 to 12, preferably 8 to 11, and more preferably 8 to 9.5.

According to one embodiment of the present invention, the substrate is a cellulose-based substrate, a plastic, or a metal, preferably a cellulose-based substrate, and more preferably a paper, a paper board, or a card board.

According to one embodiment of the present invention, the coated article comprises a pre-coating between the at least one surface of the substrate and the coating, wherein the pre-coating comprises at least one mineral, preferably talc and/or calcium carbonate, and a binder.

For purposes of the present invention, the following terms have the following meanings:

A “polymer comprising units derived from” a specific monomer means that the polymer is obtained by polymerizing at least the specific monomer (e.g. methacrylate, methacrylic acid, etc).

“Methacrylate” describes an ester of methacrylic acid and “acrylate” an ester of acrylic acid. “Maleate” describes a mono- or diester (preferably diester) of maleic acid.

The “particle size” of particulate materials herein is described by its distribution of particle sizes dₓ. Therein, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀(wt.) unless indicated otherwise. Particle sizes may be determined by using a Sedigraph™ 5120 instrument of Micromeritics Instrument Corporation. The method and the instrument are known to the skilled person and are commonly used to determine the particle size of fillers and pigments. The measurements may be carried out in an aqueous solution of 0.1 wt.-% Na₄P₂O₇.

A “calcium carbonate-containing material” in the meaning of the present invention is a mineral material or a synthetic material having a content of calcium carbonate of at least 50 wt.-%, based on the total weight of the calcium carbonate-containing material.

Where an indefinite or definite article is used when referring to a singular noun, e.g., “a”, “an” or “the”, this includes a plural of that noun unless anything else is specifically stated. Where the term “comprising” is used in the present description and claims, it does not exclude other elements.

For the purposes of the present invention, the term “consisting of” and “essentially consisting of” is considered to be a preferred embodiment of the term “comprising”. If hereinafter a group is defined to comprise at least a certain number of embodiments, this is also to be understood to disclose a group, which preferably consists only of these embodiments or essentially consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

### DETAILED DESCRIPTION

In the following, the aspects and embodiments of the present invention are described in more detail.

### Aqueous Coating Composition and Process for Preparing the Same

In one aspect, the invention relates to an aqueous coating composition. The aqueous coating composition comprises
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) a calcium carbonate-containing material in an amount in the range of 0.1 to below 20 wt. %, based on the total dry weight of the coating composition; and
(d) optionally a wax.

### Polymer A

The aqueous coating composition according to the invention comprises a polymer A comprising units derived from an alpha-olefin and one or more (e.g. one to three) comonomers selected from the group of methacrylates, acrylates, methacrylic acid, acrylic acid, maleates, maleic acid, maleic anhydride, and salts thereof.

The alpha-olefin is preferably a C₂-C₄ alpha-olefin, and most preferably ethylene.

Suitable methacrylates may be alkyl methacrylates, optionally a C₁-C₆-alkyl methacrylates such as methyl methacrylate or butyl methacrylate.

Suitable acrylates may be alkyl acrylates, optionally C₁-C₆-alkyl acrylates such as methyl acrylate or butyl acrylate.

Suitable maleates may be dialkyl maleates, optionally di-C₁-C₆-alkyl maleates.

According to one preferred embodiment, polymer A comprises, preferably consists of, units derived from an alpha-olefin, preferably ethylene, and one or more (e.g. one to three) comonomers selected from the group of methacrylates, acrylates, methacrylic acid, acrylic acid, and salts thereof.

Polymer A can have a specific comonomer content. Preferably, polymer A has a comonomer content (methacrylates, acrylates, methacrylic acid, maleates, maleic acid, maleic anhydride, and/or acrylic acid) in the range from 0.5 to 25 mol-%, preferably from 5 to 25 mol-%, more preferably from 15 to 25 mol-%, like in the range of from 15 to 22 mol-%.

In another preferred embodiment, polymer A has a comonomer content (methacrylates, acrylates, methacrylic acid, maleates, maleic acid, maleic anhydride, and/or acrylic acid) in the range from 5 to 25 mol-% (e.g. 8 to 22 mol-%), more preferably from 5 to 15 mol-%, even more preferably from 5 to 12 mol-%, like in the range of 8 to 12 mol-%.

Polymer A may be present in partially or fully neutralized form. “Neutralized” means in the context of polymers A and B that a carboxylic acid group of polymer units derived from methacrylic acid and/or acrylic acid is neutralized by mono-, di-, and/or trivalent cations, such as alkali cations (e.g. Li⁺, Na⁺, NH₄⁺). According to one embodiment, polymer A is present in partially neutralized form. According to one preferred embodiment, polymer A is present in fully neutralized form.

According to one preferred embodiment, polymer A is a polymer of ethylene and acrylic acid, and optionally methacrylic acid. Most preferably, polymer A is a copolymer of ethylene and acrylic acid. The copolymer of ethylene and acrylic acid preferably can have a comonomer content of acrylic acid in the range of in the range from 0.5 to 30 mol-%, preferably from 5 to 25 mol-%, more preferably from 15 to 25 mol-%, like in the range of from 15 to 22 mol-%. For example, the acrylic acid-content of the ethylene-acrylic acid-copolymer may be about 20 mol-%. The ethylene-acrylic acid copolymer can have a weight amount of acrylic acid in the range of 5 to 30 wt. %, preferably 10 to 25 wt. %, and more preferably 12 to 20 wt. %.

The copolymer of ethylene and acrylic acid preferably can have a comonomer content of acrylic acid in the range of in the range from 5 to 25 mol-% (e.g. 8 to 22 mol-%), more preferably from 5 to 15 mol-%, even more preferably from 5 to 12 mol-%, like in the range of 8 to 12 mol-%. For example, the acrylic acid-content of the ethylene-acrylic acid-copolymer may be about 10 mol-%.

A suitable ethylene-acrylic acid copolymer has the CAS no. 9010-77-9.

Polymer A can be present in the aqueous coating composition in a weight amount of 55 to 98 wt. %, preferably 60 to 85 wt. %, more preferably 60 to 80 wt. %, even more preferably 60 to 70 wt. %, based on the total dry weight of the coating composition.

### Polymer B

The aqueous coating composition according to the invention comprises a polymer B comprising units derived from one or more (e.g. one to five) monomers selected from the group of methacrylates, acrylates, methacrylic acid, acrylic acid, maleates, maleic acid, maleic anhydride, and salts thereof.

It is to be understood that polymer A and polymer B are different polymers, which means for this invention that at least one polymer unit in polymer A is different from the polymer unit(s) in polymer B.

Suitable methacrylate monomers are methyl methacrylate, butyl methacrylate, hexyl methacrylate, isobutyl methacrylate, isopropyl methacrylate, sec-butyl methacrylate, cyclohexyl methacrylate, isodecyl methacrylate, isobornyl methacrylate, t-butylaminoethyl methacrylate, stearyl methacrylate, glycidyl methacrylate, dicyclopentenyl methacrylate, and phenyl methacrylate. Preferred methacrylate monomers are methyl methacrylate, butyl methacrylate, hexyl methacrylate, isobutyl methacrylate, isopropyl methacrylate. More preferred methacrylate monomers are butyl methacrylate and methyl methacrylate.

Suitable acrylate monomers are methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, and 2-hydroxyethyl acrylate. Preferred acrylate monomers are methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, and 2-hydroxyethyl acrylate. More preferred acrylate monomers are methyl acrylate, ethyl acrylate, butyl acrylate, 2-ethylhexyl acrylate, octyl acrylate, and isooctyl acrylate. Suitable maleates are dialkyl maleates, optionally di-C₁-C₆-alkyl maleates. Polymer B can be present in partially or fully neutralized form. According to one embodiment, the first polymer is present in partially neutralized form. According to one preferred embodiment, the first polymer is present in fully neutralized form.

According to one embodiment, polymer B comprises units derived from one or more (e.g. from one to five) monomers selected from the group of alkyl methacrylates, alkyl acrylates, methacrylic acid, acrylic acid, dialkyl maleates, maleic acid, maleic anhydride, and salts thereof. According to one embodiment, polymer B comprises units derived from one or more (e.g. from one to five) monomers selected from the group of alkyl methacrylates, alkyl acrylates, methacrylic acid, acrylic acid, and salts thereof. According to one preferred embodiment, polymer B comprises units derived from one or more, preferably two to four, monomers selected from the group of C₁-C₆-alkyl methacrylates, C₁-C₆-alkyl acrylates, methacrylic acid, acrylic acid, di-C₁-C₆-alkyl maleates, maleic acid, maleic anhydride, and salts thereof. According to one preferred embodiment, polymer B comprises units derived from one or more, preferably two to four, monomers selected from the group of C₁-C₆-alkyl methacrylates, C₁-C₆-alkyl acrylates, methacrylic acid, acrylic acid, and salts thereof. According to one preferred embodiment, polymer B comprises units derived from one to five, preferably two to four, monomers selected from the group of C₁-C₆-alkyl methacrylates, C₁-C₆-alkyl acrylates, methacrylic acid, acrylic acid, and salts thereof.

According to one embodiment, polymer B comprises, preferably consists of, units derived from one or more, preferably two to four, monomers selected from the group of alkyl methacrylates, alkyl acrylates, methacrylic acid, acrylic acid, and salts thereof. According to one preferred embodiment, polymer B consists of units derived from one or more, preferably two to four, monomers selected from the group of C₁-C₆-alkyl methacrylate, C₁-C₆-alkyl acrylate, methacrylic acid, acrylic acid, and salts thereof. According to one preferred embodiment, polymer B consists of units derived from one to five, preferably two to four, monomers selected from the group of C₁-C₆-alkyl methacrylates, C₁-C₆-alkyl acrylates, methacrylic acid, acrylic acid, and salts thereof.

According to one preferred embodiment of the invention, polymer B is a polymer of acrylic acid and from one to three acrylate and/or methacrylate monomers. According to one preferred embodiment of the invention, polymer B is a polymer of acrylic acid and from one to three alkyl acrylate and/or alkyl methacrylate monomers. According to one preferred embodiment of the invention, polymer B is a polymer of acrylic acid and from one to three C₁-C₆-alkyl acrylate and/or C₁-C₆-alkyl methacrylate monomers.

According to one more preferred embodiment, polymer B is a polymer of acrylic acid, butyl acrylate, butyl methacrylate and methyl methacrylate. A suitable polymer B has the CAS no. 51981-89-6.

According to another embodiment, polymer B is an acrylic acid-acrylate copolymer, preferably an acrylic acid-C₁-C₆-alkyl acrylate copolymer.

Polymer B can be present in the aqueous coating composition in a weight amount of 1 to 30 wt. %, preferably 5 to 25 wt. %, more preferably 10 to 25 wt. %, even more preferably 15 to 25 wt. %, based on the total dry weight of the coating composition.

### Calcium Carbonate-Containing Material

The aqueous coating composition according to the invention comprises a calcium carbonate-containing material.

The calcium carbonate-containing material may be a natural ground calcium carbonate, a precipitated calcium carbonate, or a mixture thereof.

In one embodiment, the calcium carbonate-containing material is a precipitated calcium carbonate. “Precipitated calcium carbonate” (PCC) in the meaning of the present invention is a synthesized material, generally obtained by precipitation following reaction of carbon dioxide and calcium hydroxide in an aqueous environment or by precipitation of calcium and carbonate ions, for example CaCl₂) and Na₂CO₃, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried.

According to one embodiment, the precipitated calcium carbonate is precipitated calcium carbonate, preferably comprising aragonitic, vateritic or calcitic mineralogical crystal forms or mixtures thereof.

In a preferred embodiment, the calcium carbonate-containing material is a natural ground calcium carbonate. Preferably, the natural ground calcium carbonate is selected from the group consisting of chalk, limestone, marble, dolomite and mixtures thereof. In another preferred embodiment, the natural ground calcium carbonate is selected from the group consisting of chalk, limestone or marble. More preferably, the natural ground calcium carbonate is limestone or marble, and most preferably is marble.

A natural ground calcium carbonate may be obtained, for example, in a wet and/or dry comminution step, such as crushing and/or grinding, from natural calcium carbonate-containing minerals (e.g. chalk, limestone, marble or dolomite). According to one embodiment, the natural ground calcium carbonate is a wet-natural ground calcium carbonate. In another embodiment, the natural ground calcium carbonate is a dry-natural ground calcium carbonate.

A natural ground calcium carbonate may be obtained, for example, in a wet and/or dry comminution step, such as crushing and/or grinding, from natural calcium carbonate-containing minerals (e.g. chalk, limestone, marble or dolomite). According to one embodiment, the natural ground calcium carbonate is a natural wet-ground calcium carbonate. In another embodiment, the natural ground calcium carbonate is a natural dry-ground calcium carbonate.

The grinding step can be carried out with any conventional grinding device, for example, under conditions such that refinement predominantly results from impacts with a secondary body, i.e. in one or more of a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. The grinding step may also be performed under conditions such that autogenous grinding takes place and/or by horizontal ball milling, and/or other such processes known to the skilled man.

In one embodiment, grinding is carried out in a vertical or horizontal ball mill, preferably in a vertical ball mill. Such vertical and horizontal ball mills usually consist of a vertically or horizontally arranged, cylindrical grinding chamber comprising an axially fast rotating agitator shaft being equipped with a plurality of paddles and/or stirring discs, such as described for example in EP0607840 A1.

It is to be noted that grinding of the calcium carbonate mineral may be carried out by using at least one of the aforementioned grinding methods or devices. However, it is also possible to use a combination of any of the foregoing methods or a series of any of the aforementioned grinding devices.

Subsequent to the grinding step, the ground calcium carbonate mineral may, optionally, be divided into two or more fractions, each having different particle distributions, by use of a classifying step. A classifying step in general serves to divide a feed fraction having a certain particle size distribution into a coarse fraction, which may be subjected to another grinding cycle, and a fine fraction, which may be used as the final product. For this purpose, screening devices as well as gravity-based devices, such as centrifuges or cyclones (e.g. hydrocyclones) and any combination of the aforementioned devices may be used.

According to one embodiment, the calcium carbonate-containing material has a calcium carbonate content of at least 75 wt.-%, preferably at least 90 wt.-%, and most preferably at least 95 wt.-%, based on the total weight of the calcium carbonate-containing material. According to one preferred embodiment, the calcium carbonate-containing material is a natural ground calcium carbonate (e.g. obtained from marble) having a calcium carbonate content of at least 75 wt.-%, preferably at least 90 wt.-%, and most preferably at least 95 wt.-%, based on the total weight of the calcium carbonate-containing material.

The calcium carbonate-containing material is preferably characterized by a specific particle size. According to one embodiment of the present invention, the calcium carbonate-containing material has a weight-median particle size d₅₀ in the range of 0.1 to 15 microns, preferably 0.1 to 5 microns, and more preferably 0.1 to 3 microns.

According to one embodiment of the present invention, the calcium carbonate-containing material has a top cut weight particle size d₉₈ in the range of 0.5 to 30 microns, preferably 0.5 to 20 microns, and more preferably 0.5 to 15 microns.

According to one preferred embodiment, the calcium carbonate-containing material has a weight-median particle size d₅₀ in the range of 0.1 to 15 microns, preferably 0.1 to 5 microns, more preferably 0.1 to 3 microns, and even more preferably 0.1 to 1.5 microns, and a top cut weight particle size d₉₈ in the range of 0.5 to 30 microns, preferably 0.5 to 20 microns, more preferably 0.5 to 15 microns, and even more preferably 0.5 to 5 microns.

According to one preferred embodiment, the calcium carbonate is a natural ground calcium carbonate, preferably obtained from marble, having a calcium carbonate content of at least 90 wt. %. preferably at least 95 wt. %, based on the total weight of the calcium carbonate-containing material, having a weight-median particle size d₅₀ in the range of 0.1 to 15 microns, preferably 0.1 to 5 microns, more preferably 0.1 to 3 microns, and even more preferably 0.1 to 1.5 microns, and a top cut weight particle size d₉₈ in the range of 0.5 to 30 microns, preferably 0.5 to 20 microns, more preferably 0.5 to 15 microns, and even more preferably 0.5 to 5 microns.

According to one embodiment, the calcium carbonate-containing material has a weight-median particle size d₅₀ in the range of 0.1 to below 0.8 microns, and more preferably 0.1 to below 0.5 microns, and/or a top cut weight particle size d₉₈ in the range of 0.5 to below 4 microns, preferably 0.5 to 1.5 microns (e.g. from 0.5 to 1.0 microns). According to one embodiment, the calcium carbonate-containing material has a weight-median particle size d₅₀ in the range of 0.1 to below 0.8 microns, and more preferably 0.1 to below 0.5 microns, and a top cut weight particle size d₉₈ in the range of 0.5 to below 4 microns, preferably 0.5 to 1.5 microns (e.g. from 0.5 to 1.0 microns). According to one preferred embodiment, the calcium carbonate-containing material has (i) a calcium carbonate content of at least 90 wt. %. preferably at least 95 wt. %, based on the total weight of the calcium carbonate-containing material, (ii) a weight-median particle size d₅₀ in the range of 0.1 to below 0.8 microns, and more preferably 0.1 to below 0.5 microns, (iii) a top cut weight particle size d₉₈ in the range of 0.5 to below 4 microns, preferably 0.5 to 1.5 microns (e.g. from 0.5 to 1.0 microns), and (iv) is a natural ground calcium carbonate, preferably obtained from marble.

The inventors surprisingly found that the particle size of the calcium carbonate-containing material of the inventive coating composition influences the heat sealability of the coated article. The finer the particle size of the material is, the lower is the temperature for achieving a very good heat sealing. A low temperature for achieving a good heat sealing is advantageous in terms of energy-efficiency and processability in heat sealing machines (e.g. hot air heat sealing machines), which usually operate with an upper limit of possible heat sealing temperature.

The calcium carbonate-containing material may further be characterized by its specific surface area. The “specific surface area” (expressed in m²/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Prior to such measurements, the sample may be filtered within a Buchner funnel, rinsed with deionised water and dried at 110° C. in an oven for at least 12 hours. The total surface area (in m²) of said material can be obtained by multiplication of the specific surface area (in m²/g) and the mass (in g) of the material.

According to one embodiment, the calcium carbonate-containing material has a specific surface area of from 0.5 m²/g to 40 m²/g, preferably from 0.5 m²/g to 30 m²/g, and more preferably from 2 m²/g to 20 m²/g, and even more preferably 10 to 20 m²/g, measured using nitrogen and the BET method.

The calcium carbonate-containing material is present in the aqueous coating composition in a weight amount of 0.1 to below 20 wt. %, based on the total dry weight of the coating composition. According to one preferred embodiment of the invention, the aqueous coating composition comprises the calcium carbonate-containing material in an amount of 0.1 to 12.5 wt. %, preferably 2 to 12.5 wt. %, and more preferably 2 to 8 wt. % (e.g. 3 to 8 wt. % or 5 to 8 wt. %), based on the total dry weight of the coating composition.

A skilled person knows how to determine the “total dry weight” of an aqueous coating composition. A method how to determine the “total dry weight” of an aqueous composition is described in the example section.

The inventors found that the addition of calcium carbonate-containing material in an amount of 0.1 to below 20 wt. % improves the hot water stability of an article, which is coated with the inventive coating composition. In case the content of the calcium carbonate-containing material is increased in the composition to 20 wt. % or above, the heat-sealability of the coated article may be decreased to an unacceptable level. A content of the material of e.g. below or equal to 12.5 wt % or below or equal to 8 wt. % can result in a very good hot water stability of the coating while achieving a comparatively low hot air sealing temperature. In such cases, an excellent sealability can even be achieved below 500° C., which is advantageous e.g. in terms of energy-efficiency and in order not to exceed maximum sealing temperatures on certain cup machines.

### Wax (Optional)

The aqueous coating composition optionally comprises a wax.

The way may be selected from the group consisting of plant waxes (e.g. carnauba wax, jojoba oil, candelilla wax, ouricury wax), animal waxes (e.g. wool wax, beeswax, china wax), hydrocarbon waxes, and mixtures thereof.

Preferably, the wax is a hydrocarbon wax, and most preferably the wax is a paraffin wax or a polyolefin wax (e.g. polyethylene wax).

Most preferably, the way is a paraffin wax. A “paraffin wax” in the meaning of the present invention is a compound derived from petroleum, coal or shale oil, which consists of a mixture of hydrocarbons, preferably hydrocarbons containing from 20 to 40 carbon atoms, and which is solid at 25° C. and begins to melt at a temperature in the range of 40 to 90° C., preferably 60 to 80° C. A suitable paraffin wax is the paraffin wax with the CAS no. 8002-74-2.

Wax can be present in the aqueous coating composition in a weight amount of 0.1 to 15 wt. %, preferably 1 to 15 wt. %, more preferably 1 to 11 wt. %, even more preferably 3 to 11 wt. %, yet even more preferably 5 to 11 wt. %, yet even more preferably 7 to 11 wt. %, based on the total dry weight of the coating composition.

### Additives (Optional)

The aqueous coating composition according to the invention optionally comprises one or more additives selected from the group of acids, bases, rheology modifiers, viscosity enhancers, antifoaming agents, biocides, tension surface modifiers and dispersing agents.

The one or more additives can be present in the aqueous coating composition in a weight amount of 0.01 to 5.0 wt. %, preferably 0.01 to 4.0 wt. %, and more preferably 0.1 to 4.0 wt. %, based on the total dry weight of the composition.

The list of additives provided herein is not exhaustive. A skilled person can select and add further additives if necessary.

### Coating Composition

The present invention relates in one aspect to an aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) a calcium carbonate-containing material in an amount in the range of 0.1 to below 20 wt. %, based on the total dry weight of the coating composition; and
(d) optionally a wax.

For preferred embodiments of polymer A, polymer B, calcium carbonate-containing material, optional wax and optional additives, it is referred to the sections above.

The expression “the aqueous coating composition comprises (c) a calcium carbonate-containing material in an amount in the range of 0.1 to below 20 wt. %, based on the total dry weight of the coating composition” is to be understood in that the aqueous coating composition comprises a calcium carbonate-containing material, wherein the calcium carbonate-containing material is present in the aqueous coating composition in an amount in the range of 0.1 to below 20 wt. %, based on the total dry weight of the coating composition.

The coating composition of the invention comprises water. In addition to water, the aqueous coating composition can comprise one or more other fluid media such as organic solvents. However, it is preferred that the coating composition only contains water as liquid medium.

The aqueous coating composition typically comprises polymer A and polymer B in a specific weight ratio with respect to each other. According to one preferred embodiment of the present invention, the aqueous coating composition comprises polymer A and polymer B in a weight ratio in the range of 50:50 to 99:1 (e.g. >50:<50 to 99:1), preferably >65:<35 to 99:1, more preferably 70:30 to 99:1, and most preferably 75:25 to 95:5.

The inventors found that using polymer A to polymer B in a specific weight ratio can further improve hot water stability (decrease hot water COBB values) of the coated article.

Further, the aqueous coating composition typically comprises a specific combined amount of polymer A and polymer B in the coating composition. According to one preferred embodiment of the present invention, the aqueous coating composition comprises 60 to 99.9 wt. %, preferably 75 to 99.9 wt. %, more preferably 85 to 95 wt. %, and even more preferably 90 to 95 wt. %, of a combined amount of polymers A and B, based on the total dry weight of the coating composition.

The aqueous coating composition typically comprises the mandatory and optional components in specific weight amounts, based on the total dry weight of the coating composition. A person of skill will have no difficulty of selecting the specific weight amounts of the mandatory and optional components in such a way that they add up to 100 wt. %. Preferably the indicated weight amounts of the mandatory and optional components are selected to add up to 100 wt. %.

According to one preferred embodiment of the invention, the aqueous coating composition comprises, based on the total weight of the coating composition:
(a) 55 to 98 wt. %, preferably 60 to 85 wt. %, more preferably 60 to 80 wt. %, even more preferably 60 to 70 wt. %, of polymer A,
(b) 1 to 30 wt. %, preferably 5 to 25 wt. %, more preferably 10 to 25 wt. %, even more preferably 15 to 25 wt. %, of polymer B,
(c) 0.5 to below 20 wt. %, preferably 2 to 12.5 wt. %, more preferably 2 to 8 wt. %, even more preferably 5 to 8 wt. %, of calcium carbonate-containing material, and
(d) optionally 0.1 to 15 wt. %, preferably 1 to 11 wt. %, even more preferably 7 to 11 wt. %, of wax.

According to one preferred embodiment of the invention, the aqueous coating composition comprises, based on the total weight of the coating composition:
(a) 55 to 98 wt. %, preferably 60 to 85 wt. %, more preferably 60 to 80 wt. %, even more preferably 60 to 70 wt. %, of polymer A,
(b) 1 to 30 wt. %, preferably 5 to 25 wt. %, more preferably 10 to 25 wt. %, even more preferably 15 to 25 wt. %, of polymer B,
(c) 0.5 to below 20 wt. %, preferably 2 to 12.5 wt. %, more preferably 2 to 8 wt. %, even more preferably 5 to 8 wt. %, of calcium carbonate-containing material, and
(d) 0.1 to 15 wt. %, preferably 1 to 11 wt. %, even more preferably 7 to 11 wt. %, of wax.

According to one preferred embodiment of the invention, the aqueous coating composition comprises, based on the total weight of the coating composition:
(a) 55 to 98 wt. %, preferably 60 to 85 wt. %, more preferably 60 to 80 wt. %, even more preferably 60 to 70 wt. %, of polymer A,
(b) 1 to 30 wt. %, preferably 5 to 25 wt. %, more preferably 10 to 25 wt. %, even more preferably 15 to 25 wt. %, of polymer B,
(c) 0.5 to below 20 wt. %, preferably 2 to 12.5 wt. %, more preferably 2 to 8 wt. %, even more preferably 5 to 8 wt. %, of calcium carbonate-containing material, and
(d) 0.1 to 15 wt. %, preferably 1 to 11 wt. %, even more preferably 7 to 11 wt. %, of wax.
(e) optionally 0.01 to 5.0 wt. %, preferably 0.01 to 4.0 wt. %, more preferably 0.1 to 4.0 wt. %, of additives.

According to one preferred embodiment of the invention, the aqueous coating composition comprises, based on the total weight of the coating composition:
(a) 55 to 98 wt. %, preferably 60 to 85 wt. %, more preferably 60 to 80 wt. %, even more preferably 60 to 70 wt. %, of polymer A,
(b) 1 to 30 wt. %, preferably 5 to 25 wt. %, more preferably 10 to 25 wt. %, even more preferably 15 to 25 wt. %, of polymer B,
(c) 0.5 to below 20 wt. %, preferably 2 to 12.5 wt. %, more preferably 2 to 8 wt. %, even more preferably 5 to 8 wt. %, of calcium carbonate-containing material, and
(d) 0.1 to 15 wt. %, preferably 1 to 11 wt. %, even more preferably 7 to 11 wt. %, of wax.
(e) 0.01 to 5.0 wt. %, preferably 0.01 to 4.0 wt. %, more preferably 0.1 to 4.0 wt. %, of additives.

According to one preferred embodiment, the aqueous coating composition comprises, based on the total weight of the coating composition:
(a) 60 to 70 wt. % of polymer A,
(b) 15 to 25 wt. % of polymer B,
(c) 5 to 8 wt. % of calcium carbonate-containing material,
(d) 7 to 11 wt. % of wax; and
(e) 0.1 to 4.0 wt. %, of additives.

The aqueous coating composition typically comprises the mandatory and optional components in specific weight amounts relative to each other (dry parts per weight).

According to one embodiment of the invention, the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of calcium carbonate-containing material, and
(d) optionally 1 to 15, preferably 5 to 12, more preferably 7 to 12, parts per weight of wax.

According to one embodiment of the invention, the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of calcium carbonate-containing material, and
(d) 1 to 15, preferably 5 to 12, more preferably 7 to 12, parts per weight of wax.

According to one embodiment of the invention, the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of calcium carbonate-containing material,
(d) 1 to 15, preferably 5 to 12, more preferably 7 to 12, parts per weight of wax, and
(e) optionally 0.01 to 7.5, preferably 0.1 to 5, parts per weight of additives.

According to one embodiment of the invention, the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of calcium carbonate-containing material,
(d) 1 to 15, preferably 5 to 12, more preferably 7 to 12, parts per weight of wax, and

(e) 0.01 to 7.5, preferably 0.1 to 5, parts per weight of additives.

According to one embodiment, the aqueous coating composition comprises:
(a) 70 to 95 parts per weight of polymer A,
(b) 5 to 25 parts per weight of polymer B,
(c) 2 to 9 parts per weight of calcium carbonate-containing material,
(d) 7 to 12 parts per weight of wax, and
(e) 0.1 to 5 parts per weight of additives.

The aqueous coating composition according to the invention may have a specific solids content, pH value, and/or viscosity.

According to one embodiment, the aqueous coating composition has a solids content in the range of 5 to 70 wt. %, preferably of 20 to 60 wt. %, and more preferably 30 to 50 wt. %.

According to one embodiment, the aqueous coating composition has a pH value in the range of 7.5 to 12, preferably 8 to 11, and more preferably 8 to 9.5 (e.g. 8.0 to 9.0).

The aqueous coating composition can have a viscosity (at 100 rpm) in the range to 25 to 2000 mPa*s according to ISO 1652:2011. The viscosity can depend on the amount of calcium carbonate-containing material being present in the composition. According to one embodiment, the aqueous coating composition has a viscosity (at 100 rpm) according to ISO 1652:2011 in the range of 25 to 500 mPa*s, e.g. 35 to 100 mPa*s.

According to one embodiment, the aqueous coating composition has a solids content in the range of 5 to 70 wt. %, preferably of 20 to 60 wt. %, and more preferably 30 to 50 wt. %, and a pH value in the range of 7.5 to 12, preferably 8 to 11, more preferably 8 to 9.5, and most preferably 8 to 9. According to one embodiment, the aqueous coating composition has a solids content in the range of 5 to 70 wt. %, preferably of 20 to 60 wt. %, and more preferably 30 to 50 wt. %, a pH value in the range of 7.5 to 12, preferably 8 to 11, and more preferably 8 to 9.5 (e.g. 8.0 to 9.0), and a viscosity according to ISO 1652:2011 in the range of 25 to 500 mPa*s (e.g. 35 to 100 mPa*s).

According to a preferred embodiment, the aqueous coating composition comprises a dispersing agent as an additive. The dispersing agent may be used to disperse the calcium carbonate-containing material in the composition.

The aqueous coating composition as defined herein is obtainable or can be obtained by a process comprising the steps of:
providing an aqueous composition I, preferably an aqueous dispersion, comprising polymer A and preferably a wax,
providing an aqueous composition II, preferably an aqueous dispersion, comprising polymer B and preferably a wax,
providing a calcium carbonate-containing material,
mixing the aqueous composition I and II and the calcium carbonate-containing material.

The mixing step can be carried out in any order. It is however preferred that the aqueous compositions I and II comprising polymer A and B are mixed first, followed by addition of the calcium carbonate-containing material.

In one preferred embodiment, aqueous composition I is an aqueous dispersion comprising polymer A and a wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %).

In one preferred embodiment, aqueous composition II is an aqueous dispersion comprising polymer B and a wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %).

The calcium carbonate-containing material may be provided in solid or in liquid form. Preferably the calcium carbonate-containing material is provided in liquid form, more preferably as an aqueous composition. Hence, the aqueous coating composition as defined herein is obtainable or can be obtained by a process comprising the steps of:
providing an aqueous composition I, preferably an aqueous dispersion, comprising polymer A and preferably a wax,
providing an aqueous composition II, preferably an aqueous dispersion, comprising polymer B and preferably a wax,
providing an aqueous composition III comprising the calcium carbonate-containing material,
mixing the aqueous composition I to III in any order, and preferably mixing the aqueous composition I and II, followed by adding the aqueous composition III.

In one preferred embodiment, the calcium carbonate-containing material is provided in form of an aqueous composition III, which is an aqueous suspension comprising calcium carbonate-containing material, wherein the suspension has a solids content in the range of 1 to 85 wt. % preferably 50 to 85 wt. %. Preferably, the calcium carbonate-containing material is dispersed by a dispersing agent.

According to one preferred embodiment, the aqueous coating composition is obtainable or obtained by a process comprising the steps of:
providing an aqueous composition I which is: an aqueous dispersion comprising polymer A and a wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and a wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing an aqueous composition III which is: an aqueous suspension comprising the calcium carbonate-containing material, wherein the suspension has a solids content in the range of 1 to 85 wt. % preferably 50 to 85 wt. %,
mixing the aqueous compositions I and II, followed by the addition of the aqueous composition III,
optionally followed by one or more steps selected from adjusting the pH value, adjusting the viscosity and adding additives.

Additives may be added to any one of aqueous compositions I to III and/or to the composition obtained by mixing aqueous compositions I to III.

### Process for Preparing the Coating Composition

Another aspect of the present invention relates to a process for preparing an aqueous coating composition according to the invention. The process comprises the steps of:

providing an aqueous composition I comprising polymer A as defined herein and optionally a wax as defined herein,
providing an aqueous composition II comprising polymer B as defined herein and optionally a wax as defined herein,
providing a calcium carbonate-containing material as defined herein,
mixing the aqueous compositions I and II and the calcium carbonate-containing material.

The skilled person can select conditions or equipment for mixing the aqueous compositions I to III (and optional additives) according to her or his needs. Regarding preferred embodiments of polymer A, polymer B, calcium carbonate-containing material, optional wax and optional additives, it is referred to the above sections. Additives as defined herein can be added to any one of aqueous compositions I to III and/or to the composition obtained by mixing the aqueous compositions I to III.

The mixing step can be carried out in any order. It is however preferred that the aqueous compositions I and II comprising polymer A and B are mixed first, followed by addition of the calcium carbonate-containing material.

In one preferred embodiment, aqueous composition I is an aqueous dispersion comprising polymer A and the wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %).

In one preferred embodiment, aqueous composition II is an aqueous dispersion comprising polymer B and the wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %).

The calcium carbonate-containing material may be provided in solid or in liquid form. Preferably the calcium carbonate-containing material is provided in liquid form, more preferably as an aqueous composition, and even more preferably in form of a slurry. Slurries of calcium carbonate-containing materials are well known. Preferably, the calcium carbonate-containing material is dispersed by a dispersing agent.

Hence, the process according to the invention can comprise the steps of:
providing an aqueous composition I, preferably an aqueous dispersion, comprising polymer A and preferably the wax,
providing an aqueous composition II, preferably an aqueous dispersion, comprising polymer B and preferably the wax,
providing an aqueous composition III comprising the calcium carbonate-containing material,
mixing the aqueous composition I to Ill in any order, and preferably mixing the aqueous composition I and II, followed by adding the aqueous composition III.

In one preferred embodiment, the calcium carbonate-containing material is provided in form of an aqueous composition III, which is an aqueous suspension comprising calcium carbonate-containing material, wherein the suspension has a solids content in the range of 1 to 85 wt. % preferably 50 to 85 wt. %. Preferably, the calcium carbonate-containing material is dispersed by a dispersing agent.

According to one preferred embodiment, the process comprises the steps of:
providing an aqueous composition I which is: an aqueous dispersion comprising polymer A and the wax in a weight ratio of 98:2 to 80:20, preferably 95:5 to 85:15 (e.g. about 90:10), wherein the dispersion has a solids content of 30 to 60 wt. %, preferably 35 to 50 wt. % (e.g. about 39.5 wt. %),
providing an aqueous composition II which is: aqueous dispersion comprising polymer B and the wax in a weight ratio of 98:2 to 80:20, preferably 95:5 to 85:15 (e.g. about 90:10), wherein the dispersion has a solids content of 30 to 60 wt. %, preferably 45 to 55 wt. % (e.g. about 50.5 wt. %),
providing an aqueous composition III which is: an aqueous suspension comprising calcium carbonate-containing material, wherein the suspension has a solids content in the range of 1 to 85 wt. % preferably 50 to 85 wt. %,
mixing the aqueous compositions I and II, followed by the addition of the aqueous composition III,
optionally followed by one or more steps selected from adjusting the pH value, adjusting the viscosity and adding additives.

Additives may be added to any one of aqueous compositions I to III and/or to the composition obtained by mixing aqueous compositions I to III.

### Coated Article

In another aspect, the invention refers to a coated article comprising a substrate, wherein at least one surface of the substrate comprises a coating prepared from an aqueous coating composition according to the invention.

A skilled person knows how to prepare a coating from the aqueous coating composition according to the invention. The coating may be prepared by coating at least one surface of the substrate with the aqueous coating composition, and drying the aqueous coating composition or allowing the aqueous coating composition to dry.

The coating step can be carried out by rod coating, blade coating, curtain coating or by printing techniques such as flexographic printing or offset printing. Such methods are known in the art. Rod coating as one preferred way of coating is also described in the examples.

The drying step can be carried out by hot air, air jet and/or IR drying. Such methods are also known in the art.

The substrate is not particularly limited. The substrate may be a plastic, which is suitable for use in the packaging sector such as but not limited to polyolefins (e.g. PE, PP, polystyrene), polyesters (e.g. PET, PLA), and mixtures thereof. The substrate may be a metal such as aluminum (e.g. aluminum foil). According to one embodiment, the substrate is a plastic (preferably a polyolefin, a polyester, a polystyrene, or mixtures thereof), a metal (preferably aluminum) or a cellulose-based substrate. It is preferred that the substrate is a cellulose-based substrate. Suitable cellulose-based substrates are, for example, fine paper, paper, recycled paper, paperboard, corrugated paperboard, card stock, wall paper, photo paper or tissue paper. The cellulose-based substrate is not limited to a specific shape or form. The cellulose-based substrate may be die cutted and/or cut to a specific geometrical form etc.

According to one preferred embodiment of the invention, the substrate is a cellulose-based substrate, preferably a paper, a paper board, or a card board.

The cellulose-based substrate, preferably the paper, paper board, or card board, can have a grammage in the range of from 15 to 500 g/m², more preferably from 50 to 400 g/m², and most preferably 100 to 350 g/m².

The coated article can comprise a pre-coating between the at least one surface of the substrate, preferably cellulose-based substrate, more preferably the paper, paper board, or card board, and the coating. The pre-coating may be calendared. The pre-coating can comprise at least one mineral and a binder (e.g. a latex).

The at least one mineral may be selected from the group consisting of kaolin, clay, dolomite, mica, calcium carbonate, talc, and mixtures thereof. According to one embodiment, the pre-coating comprises calcium carbonate. It is possible, sometimes preferred, that calcium carbonate is the only mineral in the pre-coating. Thus, in one embodiment, the pre-coating comprises one mineral which is calcium carbonate. It is however also possible to use, for example, a mineral mixture comprising a calcium carbonate and at least one further mineral. For example, a mineral mixture of calcium carbonate and talc may be used for the pre-coating composition. For example, the mineral mixture may be calcium carbonate and talc in a weight ratio of 60:40 to 20:80, preferably 60:40 to 40:60 (e.g. about 50:50).

The pre-coating can comprise
20 to 60, preferably 40 to 60 (e.g. about 50), parts by weight of calcium carbonate,
40 to 80, preferably 40 to 60 (e.g. about 50), parts by weight of talc,
2 to 20, preferably 5 to 15 (e.g. about 10), parts by weight of a binder (e.g. a latex),
and 0.01 to 1 parts by weight of additive, preferably rheology modifier.

The pre-coating may have a coating weight of 1 to 20 g/m², preferably 2 to 15 g/m², more preferably 3 to 12 g/m².

According to one embodiment, the coated article comprises the coating prepared from the aqueous coating composition according to the invention on the at least one surface of the substrate in an amount of 1 to 20 g/m², preferably from 2 to 15 g/m², more preferably from 5 to 15 g/m², and most preferably from 5 to 13 g/m².

It has been found that the aqueous coating composition or its dried form can be used in a comparatively low weight amount while still providing very good results in terms of barrier properties, sealability, etc. Besides needing less resources for its production, the low amount of heat-sealable coating is particularly advantageous for recycling the coated article at a later stage.

Another aspect of the present invention relates to a process for preparing a coated article according to the invention. The process preferably comprises the steps of
providing a substrate having at least one surface,
providing an aqueous coating composition as defined herein,
coating at least one surface of the substrate with the aqueous coating composition,
drying the aqueous coating composition or allowing the aqueous coating composition to dry.

The coating step can be carried out by rod coating, blade coating, curtain coating or by printing techniques such as flexographic printing, rotogravure or offset printing. Such methods are known in the art.

The drying step can be carried out by hot air, air jet and/or IR drying. Such methods are known in the art.

Further embodiments disclosed herein are defined by the following clauses:
[1] An aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) a calcium carbonate-containing material in an amount in the range of 0.1 to below 20 wt. %, based on the total dry weight of the coating composition; and
(d) optionally a wax.
[2] The aqueous coating composition according [1], wherein the aqueous coating composition comprises polymer A and polymer B in a weight ratio of 50:50 to 99:1, preferably >65:<35 to 99:1, more preferably 70:30 to 99:1, and most preferably 75:25 to 95:5.
[3] The aqueous coating composition according to [1] or [2], wherein the aqueous coating composition comprises 60 to 99.9 wt. %, preferably 75 to 99.9 wt. %, more preferably 85 to 95 wt. %, of a combined amount of polymers A and B, based on the total dry weight of the coating composition.
[4] The aqueous coating composition according to any one of [1] to [3], wherein the aqueous coating composition comprises the calcium carbonate-containing material in an amount of 0.1 to 12.5 wt. %, preferably 2 to 12.5 wt. %, and more preferably 2 to 8 wt. %, based on the total dry weight of the coating composition, and/or
   wherein the calcium carbonate-containing material has a calcium carbonate content of at least 90 wt. %, preferably of at least 95 wt. %, based on the total weight of the calcium carbonate-containing material.
[5] The aqueous coating composition according to any one of [1] to [4], wherein the aqueous coating composition comprises:
(a) 50 to 99, preferably >65 to 95, more preferably 70 to 95, parts per weight of polymer A,
(b) 1 to 50, preferably 5 to <35, more preferably 5 to 25 parts per weight of polymer B,
(c) 1 to <20, preferably 1 to 15, more preferably 2 to 9, parts per weight of the calcium carbonate-containing material, and
(d) optionally 1 to 15, preferably 5 to 12, more preferably 7 to 12, parts per weight of wax.
[6] The aqueous coating composition according to any one of [1] to [5], wherein
   the polymer A comprises, preferably consists of, units derived from an alpha-olefin, preferably ethylene, and one or more monomers selected from the group of methacrylates, acrylates, methacrylic acid, acrylic acid, and salts thereof, and/or
   the polymer B comprises, preferably consists of, units derived from one or more, preferably two to four, monomers selected from the group of methacrylates, acrylates, methacrylic acid, acrylic acid, and salts thereof.
[7] The aqueous coating composition according to any one of [1] to [6], wherein the polymer A is a copolymer of ethylene and acrylic acid, and/or the polymer B is a polymer of acrylic acid and from one to three C₁-C₆ alkyl acrylate and/or C₁-C₆ alkyl methacrylate monomers.
[8] The aqueous coating composition according to any one of [1] to [7], wherein polymer A has a comonomer content, preferably an acrylic acid content, in the range from 0.5 to 25 mol-%, preferably from 15 to 25 mol-%,
   or polymer A has a comonomer content, preferably an acrylic acid content, in the range from 5 to 30 wt. %, preferably from 10 to 25 wt. %.
[9] The aqueous coating composition according to any one of [1] to [8], wherein
   the calcium carbonate-containing material has a weight-median particle size d₅₀ in the range of 0.1 to 15 microns, preferably 0.1 to 5 microns, and more preferably 0.1 to below 0.8 microns, and/or
   the calcium carbonate-containing material has a top cut weight particle size d₉₈ in the range of 0.5 to 30 microns, preferably 0.5 to 20 microns, and more preferably 0.5 to below 4 microns.
[10] The aqueous coating composition according to any one of [1] to [9], wherein the wax is a hydrocarbon wax, preferably a paraffin wax.
[11] The aqueous coating composition according to any one of [1] to [10], wherein
   the aqueous coating composition has a solids content in the range of 5 to 70 wt. %, preferably of 20 to 60 wt. %, more preferably 30 to 50 wt. %, and/or
   the aqueous coating composition has a pH value in the range of 7.5 to 12, preferably 8 to 11, and more preferably 8 to 9.5.
[12] A process for preparing the aqueous coating composition according to any one of [1] to 11, comprising the steps of:
   providing an aqueous composition I comprising polymer A and optionally a wax,
   providing an aqueous composition II comprising polymer B and optionally a wax,
   providing a calcium carbonate-containing material,
   mixing the aqueous compositions I and II and the calcium carbonate-containing material.
[13] A coated article comprising a substrate, wherein at least one surface of the substrate comprises a coating prepared from an aqueous coating composition according to any one of [1] to [11].
[14] The coated article according to [13], wherein the substrate is a cellulose-based substrate, a plastic or a metal, preferably a cellulose-based substrate, and more preferably a paper, a paper board, or a card board.
[15] The coated article according to or [14], wherein the coated article comprises a pre-coating between the at least one surface of the substrate and the coating,
   wherein the pre-coating comprises at least one mineral, preferably talc and/or calcium carbonate, and a binder.

In the following, the present invention will be described by specific examples. The following examples shall not be construed as limiting the present invention in any way.

### Examples

### 1. Methods and Instruments

### Particle Size Distribution

In the experiments, the weight-median particle size doo and weight top cut particle size d₉₈ values were measured using a Sedigraph 5120 from the company Micromeritics Instrument Corporation, USA. The method and the instrument are known to the skilled person and are commonly used to determine grain size of fillers and pigments. The measurements were carried out in an aqueous solution comprising 0.1 wt.-% Na₄P₂O₇. The samples were dispersed using a high speed stirrer and supersonics. For the measurement of dispersed samples, no further dispersing agents were added.

### Solids Content of Aqueous Coating Composition

The suspension solids content (also known as “dry weight”) was determined using a Moisture Analyser MJ33 from the company Mettler-Toledo, Switzerland, with the following settings: drying temperature of 160° C., automatic switch off if the mass does not change more than 1 mg over a period of 30 s, standard drying of 5 to 20 g of suspension.

### Determination of Water Absorptiveness

Cobb Unger (wl5) is measured using ISO 535:1991(E). In accordance with this method, the mass of water absorbed in a specified time by g/m² of paper or board during 1800 s time under specified conditions is measured. The conditioning atmosphere is according to ISO 187 (23° C./50% RH). For the measurement of hot water absorptiveness, in accordance with this method, the mass of water at 90° C. absorbed in a specified time by g/m² of paper or board during 60 s time under specified conditions is measured.

### Preparation of Aqueous Coating Compositions

All mixing steps were done with a Pendraulik Laboratory Dissolver, model LD 50.

### Coating of Paper Substrates

The coatings were applied at a coating speed of 20 m/min using a Durrer continuous laboratory coater (Switzerland) using rod metering (X23 (23 mL/m², rod pressure of approximately 1 bar, rod revolutions of 12 rpm). Pre-coatings were applied with the same machine but with a blade aggregate: 20 m/min, blade thickness 0.3 mm and blade pressure 1 bar.

### Hot Air Sealing

Hot air sealing test were performed at the Tampere University (Finland) at the department of Materials Science and Environmental Engineering, Paper Converting and Packaging Technology. Measurement for hot air sealability were performed between temperature from 300 to 500° C. with sample size of 105 mm MD×155 mm CD (sealed area 105 mm×3 mm). The sealing force was set up to 400 N, the heat sealing time to 1.24 s, pressing time to 1.9 s and Network pressure to 6 bar. Measurements were performed in triplicate for the best value and the maximum temperature of the machine is 550° C.

Sealing was performed by (1) sealing a coated surface of the substrate to a coated surface of the substrate (hot air sealing A-A: coated side-coated side), or (2) sealing a coated surface of the substrate to a non-coated (raw) surface of the substrate (hot air sealing A-B: coated side-back side).

### Hot Clamp Sealing

Hot clamp sealing was performed on a Kopp Laboratory Sealer SGPE 3000 from the company Kopp (Reichenbach, Germany) equipped with sealing bar of 200×5 mm. The temperature was set up in a range of 90 to 160° C., with a sealing force of 100 N (0.4 N/mm²) and a time of sealing of 0.5 seconds.

### Seal Strength

Seal strength of the seal layer obtained by hot clamp sealing was measured with L&W Tensile test from the company Lorentzen & Wettre (Sweden) by an unsupported T-peel test using a test specimen having a 50 mm width. Seal strength at sealing break (peeling) were reported in Newton [N].

### 2. Materials

### Polymers

### Polymer Mix 1:

Aqueous dispersion of neutralized ethylene/acrylic acid polymer (polymer A; CAS: 9010-77-9). Polymer A has a comonomer content of acrylic acid of about 20 mol-%; solid content 40.0 wt. %; pH (ISO 976:2013) 8.5; Viscosity (ISO 1652:2011) 350±200 mPa*s.

### Polymer Mix 2:

Aqueous dispersion of neutralized acrylate/acrylic acid polymer (Polymer B; CAS: 51981-89-6); solid content 52.0 wt. %; pH (ISO 976:2013) 8.0; Viscosity (ISO 1652:2011) 250±100 mPa*s.

### Polymer Mix 3:

Aqueous dispersion of 90 wt. % (based on total dry solids) neutralized ethylene/acrylic acid polymer (polymer A; CAS: 9010-77-9) and 10 wt. % (based on total dry solids) of paraffin wax; solid content 40.0 wt. %; pH (ISO 976:2013) 8.5; Viscosity (ISO 1652:2011) 350±200 mPa*s. Polymer A has a comonomer content of acrylic acid of about 20 mol-%.

### Polymer Mix 4:

Aqueous dispersion of 90 wt. % (based on total dry solids) neutralized acrylate/acrylic acid polymer (polymer B); CAS: 51981-89-6) and 10 wt. % (based on total dry solids) of paraffin wax; solid content 51.0 wt. %; pH (ISO 976:2013) 8.0; Viscosity (ISO 1652:2011) 200±100 mPa*s.

### Polymer Mix 5:

Aqueous dispersion of 90 wt. % (based on total dry solids) neutralized ethylene/acrylic acid polymer (polymer A2; CAS: 9010-77-9) and 10 wt. % (based on total dry solids) of paraffin wax; solid content 40.0 wt. %; pH (ISO 976:2013) 8.5; Viscosity (ISO 1652:2011) 350±200 mPa*s. Polymer A2 has a comonomer content of acrylic acid of about 10 mol-%.

### Calcium Carbonate-Containing Material

### CC1:

Natural ground calcium carbonate (marble from Norway); weight-median particle size d₅₀=0.6 μm; weight-based top cut particle size d₉₈=2.2 μm; slurry with solids content 78 wt. %; specific surface area (BET): 14.3 m²/g; available from Omya, Switzerland.

### CC2:

Natural ground calcium carbonate (marble from Norway); weight-median particle size d₅₀=0.5 μm; weight-based top cut particle size d₉₈=4 μm; slurry with solids content 72 wt. %; specific surface area (BET): 10.2 m²/g; available from Omya, Switzerland.

### CC3:

Natural ground calcium carbonate (marble from Norway); weight-median particle size d₅₀=0.8 μm; weight-based top cut particle size d₉₈=4 μm; slurry with solids content 72 wt. %; specific surface area (BET): 7.8 m²/g; available from Omya, Switzerland.

### CC4:

Natural ground calcium carbonate (marble from Norway); weight-median particle size d₅₀=0.3 μm; weight-based top cut particle size d₉₉₌₁ μm; slurry with solids content 60 wt. %; specific surface area (BET): 17.7 m²/g; available from Omya, Switzerland.

### CC5:

Natural ground calcium carbonate (marble from Norway); weight-median particle size d₅₀=0.7 μm; weight-based top cut particle size d₉₈=4 μm; slurry with solids content 78 wt. %; specific surface area (BET): 11.9 m²/g; available from Omya, Switzerland.

### Pre-Coating Formulations:

### Pre1:

30 parts by weight of calcium carbonate (CC5; 27.2 wt. %, based on dry solids);
70 parts by weight of talc (Finntalc C15-B2, commercially available from Elementis, Finland; 63.5 wt. %, based on dry solids);
10 parts by weight of binder (Litex PX 9460; 9.1 wt. %, based on dry solids);
0.2 parts by weight of rheology modifier (Rheocoat 35; available from Coatex, France; 0.2 wt. %, based on dry solids).
Solids content: 61.1 wt. %; pH: 8.9; viscosity (at 100 rpm): 660 mPa*s.

### Pre2:

50 parts by weight of calcium carbonate (CC5; 45.4 wt. %, based on dry solids);
50 parts by weight of talc (Finntalc C15-B2, commercially available from Elementis, Finland; 45.4 wt. %, based on dry solids);
10 parts by weight of binder (Litex PX 9460; 9.1 wt. %, based on dry solids); 0.2 parts by weight of rheology modifier (Rheocoat 35, available from Coatex, France; 0.2 wt. %, based on dry solids).
Solids content: 61.1 wt. %; pH: 8.9; viscosity (at 100 rpm): 840 mPa*s.

### Substrates:

### Raw Paper:

Paper, 35 mottled, White (WTL), available from Visy Industries Holdings Pty Ltd, Australia (Grammage 184 g/m², Thickness 222 μm, Bulk 1.20 cm³/g, Density 0.83 g/cm³, PPS 4.91 μm, Roughness Bendtsen 267 mL/min, Air resistance Gurley 65.4 sec./100 cm³, Air permeance Bendtsen 173.7 mL/min).

### Pre1-Paper:

Raw paper coated with pre-coating formulation Pre1 (coating weight: 6.3 g/m²).

### Pre2-Paper:

Raw paper coated with pre-coating formulation Pre2 (coating weight: 6.4 g/m²).

### Pre-Coated Paper 3:

pre-coated paper, grammage 80 g/m², product name “Sappi Magnostar” commercially available from Sappi.

TABLE 1
Coating compositions and coated papers

| Example | IE1 | IE2 | IE3 | IE4 | IE5 | IE6 | IE7 | IE8 | IE9 | CE1 | CE2 |
|---|---|---|---|---|---|---|---|---|---|---|---|
| Paper substrate | Raw | Pre1- | Pre2- | Pre2- | Pre2- | Pre2- | Pre2- | Pre2- | Pre2- | Pre2- | Pre2- |
| | paper | paper | paper | paper | paper | paper | paper | paper | paper | paper | paper |
| Aqueous coating | | | | | | | | | | | |
| composition¹ | | | | | | | | | | | |
| Polymer mix 2 | | | | | | | | | 24 | | |
| Polymer mix 1 | | | | | | | | | 77 | | |
| Polymer mix 4 | 24 | 24 | 24 | 24 | 24 | 24 | 24 | 50 | | | 24 |
| Polymer mix 3 | 77 | 77 | 77 | 77 | 77 | 77 | 77 | 50 | | 100 | 77 |
| CC1 | | | | 8 | | | | | | | |
| CC2 | | | | | 8 | | | | | | |
| CC3 | | | | | | 8 | | | | | |
| CC4 | 8 | 8 | 8 | | | | 15 | 8 | 8 | | |
| Solid content | 38.8 | 38.8 | 38.8 | 38.9 | 39.2 | 38.9 | 38.9 | 39.0 | 38.9 | 38.5 | 39.1 |
| pH | 8.4 | 8.4 | 8.4 | 8.3 | 8.3 | 8.3 | 8.4 | 8.4 | 8.3 | 8.4 | 8.4 |
| Viscosity (@ 100 rpm) | 60 | 60 | 60 | 75 | 75 | 73 | 50 | 50 | 170 | 1040 | 100 |
| Coated papers | | | | | | | | | | | |
| Coating weight (g/m²) | 11.8 | 12.0 | 12.1 | 8.7 | 8.5 | 10.3 | 9.0 | 12.0 | 10.5 | 10.7 | 9.0 |
| WVTR (23° C./50% | 42.7 | 6.9 | 6.3 | 9.5 | 10.5 | 9.9 | 5.4 | 5.8 | 17.3 | 4.9 | 7.8 |
| RH) | | | | | | | | | | | |
| COBB 1800 (g/m²) | 6.3 | 6.5 | 6.1 | 2.4 | 2.7 | 2.5 | 3.0 | 6.6 | 33.6 | 2.3 | 4.7 |
| Hot water COBB (g/m²) | 34.4 | 37.8 | 40.1 | 46.2 | 41.6 | 44.1 | 40.6 | 47.6 | 56.0 | 57.6 | n.m.² |
| Hot air sealing AA | 350 (5) | 480 (5) | 410 (5) | 450 (5) | 440 (5) | 500 (4/5) | 470 (5) | 400 (5) | 550 (3) | 310 (5) | 450 (5) |
| (° C.)³ | | | | | | | | | | | |
| Hot air sealing AB | 550 (4.5) | 550 (4) | 480 (5) | 550 (3/4) | 550 (3) | 550 (3/4) | 550 (4) | 550 (4) | 550 (4) | 450 (5) | 470 (5) |
| (° C.)³ | | | | | | | | | | | |

¹Amounts are indicated in dry parts by weight.
²n.m. = not measurable; couching paper sticked to the wet surface of test paper during the couching step of the COBB test; this indicates a melting and/or instability of the coating composition upon contact with hot water.
³Adhesion value after sealing in parenthesis: 0 = no seal; 1 = weak adhesion; 2 = adhered but no fibre tear; 3 = under 50% fibre tear; 4 = over 50% fibre tear; 4.5 = over 90% fibre tear; 5 = 100% fibre tear.

The data in Table 1 shows that a paper substrate coated with the inventive coating composition IE1 to IE9 has a lower hot water absorption as determined by the hot water COBB test compared with the comparative coating composition CE1 and CE2 that do not contain calcium carbonate. The results indicate a better stability of the inventive coating towards hot water.

TABLE 2

| Example | IE10 |
|---|---|
| Paper substrate | Pre-coated paper 3 |
| Aqueous coating composition¹ | |
| Polymer mix 4 | 24 |
| Polymer mix 5 | 77 |
| CC4 | 8 |
| Solid content [%] | 38 |
| pH | 9.5 |
| Viscosity (@ 100 rpm) | 240 |
| Coated papers | |
| Coating weight (g/m²) | 10 |
| WVTR (23° C./50% RH/; g/(m²*day)) | 10.8 |
| COBB 1800 (g/m²) | 12.1 |
| Hot water COBB (g/m²) | 15.6 |
| Hot air sealing AA (° C.)² | 270 (5) |
| Hot air sealing AB (° C.)² | 360 (5) |

¹Amounts are indicated in dry parts by weight.
²Adhesion value after sealing in parenthesis: 0 = no seal; 1 = weak adhesion; 2 = adhered but no fibre tear; 3 = under 50% fibre tear; 4 = over 50% fibre tear; 4.5 = over 90% fibre tear; 5 = 100% fibre tear.

TABLE 3
Hot clamp sealing

| Example | Sealing | 90° C. | 100° C. | 110° C. | 120° C. | 130° C. | 140° C. | 150° C. | 160° C. |
|---|---|---|---|---|---|---|---|---|---|
| IE10 | AA | 9.8N | 10.1N | 11.1N | 11.4N | 11.2N | 7.3N | 11.6N | 9.7N |
| IE10 | AB | 4.1N | 4.0N | 4.0N | 3.6N | 4.2N | 4.6N | 4.7N | 4.0N |

Table 3 shows the result for sealing tests of example IE10 with hot clamps for a sealing time of 0.5 see at the indicated temperature. The force [N] reported in table 3 indicates the force necessary to break the seal.

1. An aqueous coating composition comprising
(a) a polymer A comprising units derived from an alpha-olefin and one or more comonomers selected from the group of methacrylates, acrylates, methacrylic acid, acrylic acid, maleates, maleic acid, maleic anhydride, and salts thereof;
(b) a polymer B comprising units derived from one or more monomers selected from the group of methacrylates, acrylates, methacrylic acid, acrylic acid, maleates, maleic acid, maleic anhydride, and salts thereof;
(c) a calcium carbonate-containing material in an amount in the range of 0.1 to below 20 wt. %, based on the total dry weight of the coating composition; and
(d) optionally a wax.

2. The aqueous coating composition according to claim 1, wherein the aqueous coating composition comprises polymer A and polymer B in a weight ratio of 50:50 to 99:1.

3. The aqueous coating composition according to claim 2, wherein the aqueous coating composition comprises polymer A and polymer B in a weight ratio of >65:<35 to 99:1.

4. The aqueous coating composition according to claim 1, wherein the aqueous coating composition comprises 60 to 99.9 wt. % based on the total dry weight of the coating composition.

5. The aqueous coating composition according to claim 1, wherein the aqueous coating composition comprises the calcium carbonate-containing material in an amount of 0.1 to 12.5 wt. % based on the total dry weight of the coating composition.

6. The aqueous coating composition according to claim 1, wherein the calcium carbonate-containing material has a calcium carbonate content of at least 90 wt. % based on the total weight of the calcium carbonate-containing material.

7. The aqueous coating composition according to claim 1, wherein the aqueous coating composition comprises:
(a) 50 to 99 parts per weight of polymer A,
(b) 1 to 50 parts per weight of polymer B,
(c) 1 to <20 parts per weight of the calcium carbonate-containing material, and
(d) optionally 1 to 15 parts per weight of wax.

8. The aqueous coating composition according claim 1, wherein the polymer A comprises units derived from an alpha-olefin, and one or more monomers selected from the group of methacrylates, acrylates, methacrylic acid, acrylic acid, and salts thereof.

9. The aqueous coating composition according to claim 1, wherein the polymer B comprises units derived from one or more, monomers selected from the group of methacrylates, acrylates, methacrylic acid, acrylic acid, and salts thereof.

10. The aqueous coating composition according to claim 1, wherein the polymer A is a copolymer of ethylene and acrylic acid.

11. The aqueous coating composition according to claim 1, wherein the polymer B is a polymer of acrylic acid and from one to three C₁-C₆ alkyl acrylate and/or C₁-C₆ alkyl methacrylate monomers.

12. The aqueous coating composition according to claim 1, wherein polymer A has a comonomer content in the range from 0.5 to 25 mol-%, preferably from 5 to 25 mol-%.

13. The aqueous coating composition according to claim 1, wherein
the calcium carbonate-containing material has a weight-median particle size d₅₀ in the range of 0.1 to 15 microns and/or
the calcium carbonate-containing material has a top cut weight particle size d₉₈ in the range of 0.5 to 30 microns.

14. The aqueous coating composition according to claim 1, wherein the wax is a hydrocarbon wax.

15. The aqueous coating composition according to claim 1, wherein
the aqueous coating composition has a solids content in the range of 5 to 70 wt. %, and/or
the aqueous coating composition has a pH value in the range of 7.5 to 12.

16. A process for preparing the aqueous coating composition according to claim 1, comprising the steps of:
providing an aqueous composition I comprising polymer A and optionally a wax,
providing an aqueous composition II comprising polymer B and optionally a wax,
providing a calcium carbonate-containing material,
mixing the aqueous compositions I and II and the calcium carbonate-containing material.

17. A coated article comprising a substrate, wherein at least one surface of the substrate comprises a coating prepared from an aqueous coating composition according to claim 1.

18. The coated article according to claim 17, wherein the substrate is a cellulose-based substrate, a plastic or a metal.

19. The coated article according to claim 17, wherein the coated article comprises a pre-coating between the at least one surface of the substrate and the coating, and
wherein the pre-coating comprises at least one mineral and a binder.
